(19) United States
(12) Patent Application Publication
(10) Pub. No.: US 2022/0073713 A1
(43) Pub. Date: Mar. 10, 2022

(54) TREAD FOR A TIRE

(71) Applicant: COMPAGNIE GENERALE DES ETABLISSEMENTS MICHELIN, Clermont-Ferrand (FR)

(72) Inventors: JOSE MERINO LOPEZ, Clermont-Ferrand (FR); JOSE CARLOS ARAUJO DA SILVA, Clermont-Ferrand (FR); AURORE CROCHET, Clermont-Ferrand (FR); GUILLAUME HENNEBERT, Clermont-Ferrand (FR)

(21) Appl. No.: 17/416,654

(22) PCT Filed: Dec. 10, 2019
(86) PCT No.: PCT/FR2019/052998

§ 371 Date: Jun. 21, 2021

(30) Foreign Application Priority Data
Dec. 21, 2018 (FR) FR1873881

(51) Int. Cl. C08L 23/08; B60C 1/00; B60C 11/00; B60C 11/03; C08K 5/00; C08K 3/013; C08F 210/02

(52) U.S. Cl. CPC C08L 23/08; B60C 1/0016; B60C 11/0058; B60C 11/03; B60C 2011/0025; C08K 3/013; C08F 210/02; B60C 2011/0341; C08K 5/0016

(57) ABSTRACT

A tire has a tread axially separated into at least three portions, a central portion and two lateral portions, in which the rubber composition of the lateral portions comprises more than 50 phr of a copolymer of ethylene and of a 1,3-diene, a reinforcing filler and a plasticizing system, the 1,3-diene being 1,3-butadiene or isoprene and the ethylene units in the copolymer representing more than 50 mol % of all the monomer units of said copolymer.

### FIELD OF THE INVENTION

The subject of the present invention is a vehicle tyre and, in particular, the tread of a vehicle tyre.

### PRIOR ART

Since a tyre has a geometry exhibiting symmetry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively. The expressions “radially”, “axially” and “circumferentially” mean “in the radial direction”, “in the axial direction” and “in the circumferential direction”, respectively.

“Radially inner and radially outer, respectively” is understood to mean “closer to and further away from the axis of rotation of the tyre, respectively”. “Axially inner and axially outer, respectively” is understood to mean “closer to and further away from the equatorial plane of the tyre, respectively”, the equatorial plane of the tyre being the plane EP which passes through the middle of the tread surface of the tyre and is perpendicular to the axis of rotation of the tyre.

The tread is the part of the tyre intended to come into contact with the ground via a tread surface, and extending radially from a bottom surface to the tread surface, axially from a first tread edge to a second tread edge defining the axial width of the tread, and circumferentially over the whole periphery of the tyre. The tread, regardless of whether the tyre is intended to be fitted on a passenger vehicle or a heavy-duty vehicle, is provided with a tread pattern comprising, notably, tread pattern elements or elementary blocks delimited by various main, longitudinal or circumferential, transverse or oblique grooves, the elementary blocks also being able to have various finer slits or sipes. The grooves form channels for draining off water when running on wet ground.

Radially inside the tread, a radial-type tyre comprises a reinforcement, consisting of a crown reinforcement and a radial carcass reinforcement radially inside the crown reinforcement. The crown reinforcement comprises at least one crown layer consisting of reinforcing elements or reinforcers coated with a rubber mixture and parallel to one another. The radial carcass reinforcement comprises at least one carcass layer consisting of reinforcers coated with a rubber mixture, parallel to one another and oriented substantially radially, that is to say forming, with the circumferential direction, an angle of between 85° and 95°.

The rubber compositions of tyre treads are adapted for performance in terms of contact with a ground on which they are running, this being up to the regulatory wear of the tyres. The tread of a tyre is responsible for a large part of the rolling resistance of that tyre. This contribution is of course very variable depending on the design of the tyre, but an order of magnitude of about 50% can be achieved.

It is usual to adjust the materials closest to the plies of the crown reinforcement of the tyre, in order, among other things, to minimize rolling resistance, for example with the introduction of a low hysteresis underlayer. It should be noted that an underlayer does not come into contact with the ground on which it is running, in the course of the regulatory life of the tyre.

It is also possible to further adapt the materials of the tread. There may be two different types of rubber compositions across the width of the tread. Document EP 2594413 B1 presents such a tread with a central portion and two lateral portions, such that the rubber mixture of the lateral portions has a tensile dynamic modulus and a hysteresis that are lower than those of the central portion in order to optimize the rolling resistance and the handling of the tyre.

The performance compromise between rolling resistance and wear resistance of treads has been improved by the introduction into a rubber composition of a copolymer of ethylene and of 1,3-butadiene containing more than 50 mol % of ethylene units. Reference may be made, for example, to patent application WO 2014/114607 A1. However, such a composition does not make it possible to give the tread optimum grip performance, in particular for a passenger vehicle.

It is known that the grip performance of a tyre can be improved by increasing the contact area of the tread on the ground on which it is running. One solution consists in using a highly deformable tread, in particular a highly deformable rubber composition which constitutes the surface of the tread intended to come into contact with the running surface. The use of a very soft rubber composition, which is nevertheless favourable for grip, can lead to a deterioration in the handling of the tyre.

It is known that a greater stiffness of the tread is desirable for improving handling, it being possible for this stiffening of the tread to be obtained for example by increasing the content of reinforcing filler in the constituent rubber compositions of these treads or by incorporating certain reinforcing resins into said constituent rubber compositions of these treads. However, generally, these solutions are not always satisfactory, because they can be accompanied by a deterioration of the rolling resistance.

To meet these two contradictory requirements, which are handling and grip, one solution also consists in creating a stiffness gradient by a phenomenon of accommodation of the rubber composition of the tread as described in patent applications WO 02/10269 and WO 2012/084599. This accommodation phenomenon results in the ability of the rubber composition to become less stiff at the surface of the tread under the effect of the deformations undergone by the tread during the rolling of the tyre. This decrease in stiffness at the surface of the tread does not occur or occurs very little inside the tread, which thus maintains a higher level of stiffness than the surface of the tread.

These technical solutions for improving the grip performance, handling performance and rolling resistance performance have generally been described for highly unsaturated diene elastomers which are characterized by a molar content of diene much greater than 50%.

A rubber composition comprising a copolymer of ethylene and of 1,3-butadiene, the processability of which is improved by the introduction of 5 to 10 phr of a plasticizing resin, is described in patent application JP 2013-185048. Not only is the molar content of ethylene in the copolymer much less than 50%, but the grip performance is also not addressed.

For the use of conjugated diene copolymers containing molar contents of ethylene greater than 50% in rubber compositions for a tyre tread, there is therefore an interest and a need to also improve the grip performance of the tread.

Continuing its efforts, the applicant has discovered that the combined use of a highly saturated diene elastomer and a specific plasticizing system in a rubber composition for a tyre tread makes it possible to improve the grip performance of the tyre. Particular embodiments of the invention even help to improve the performance compromise between grip and rolling resistance. Other particular embodiments of the invention also make it possible to improve the performance compromise between grip and handling.

### BRIEF DESCRIPTION OF THE INVENTION

One subject of the invention is a tyre having an axis of rotation and a median plane perpendicular to the axis of rotation, and comprising two beads, two sidewalls connected to the beads, a crown connected to the ends of the two sidewalls with a crown reinforcement, and a radially outer rubber tread, the tread being axially separated into three portions, a central portion and two lateral portions. This tyre is characterized in that the rubber composition of the lateral portions comprises more than 50 phr of a copolymer of ethylene and of a 1,3-diene, a reinforcing filler and a plasticizing system, the 1,3-diene being 1,3-butadiene or isoprene and the ethylene units in the copolymer representing more than 50 mol % of all the monomer units of the copolymer.

The particular rubber composition of the two lateral portions makes it possible to improve the wear resistance of the tyre and in particular the wear pattern on the shoulders of the tyre. It also makes it possible to reduce the rolling resistance of the tyre during running.

According to a first variant, the tread comprising a plurality of tread pattern elements with lateral faces and a contact face intended to come into contact with the roadway when the tyre is running and a plurality of circumferential grooves each delimited by lateral faces of adjacent tread pattern elements that face one another, and delimited by a base, the central portion extends axially on either side of the median plane of the tyre beyond the plurality of circumferential grooves, and in which said central portion includes the bases of said circumferential grooves.

According to a second variant, the tread comprising a plurality of tread pattern elements with lateral faces and a contact face intended to come into contact with the roadway when the tyre is running and a plurality of circumferential grooves each delimited by lateral faces of adjacent tread pattern elements that face one another, and delimited by a base, the central portion extends axially to the axially outermost circumferential groove, at least on one side of the median plane of the tyre and preferably on either side of the median plane of the tyre.

According to one advantageous embodiment, the tread comprising a radially inner first layer C1 and a radially outer second layer C2, the lateral portions of the first layer C1 constitute the lateral portions and the second layer C2 constitutes the central portion of the tread.

The rubber composition of the lateral portions of the tread may comprise a second elastomer, preferably a diene elastomer, that is to say comprising diene monomer units. The content of the second elastomer is preferably less than 30 phr and very preferentially less than 10 phr.

The second elastomer can be a highly unsaturated diene elastomer selected from the group consisting of polybutadienes, polyisoprenes, butadiene copolymers, isoprene copolymers and mixtures of these elastomers.

Advantageously, the copolymer of ethylene and of a 1,3-diene is the only elastomer of the rubber composition of the lateral portions of the tread.

According to one embodiment variant of the tyre according to the invention, the rubber composition of the central portion of the tread comprises less than 50 phr of a copolymer of ethylene and of a 1,3-diene, a reinforcing filler and a plasticizing system, the 1,3-diene being 1,3-butadiene or isoprene and the ethylene units in the copolymer representing more than 50 mol % of all the monomer units of the copolymer.

Preferentially, the ratio K between the dynamic shear modulus of the rubber composition of the lateral portions of the tread and the dynamic shear modulus of the rubber composition of the central portion of the tread is greater than 1.1 and preferably greater than 1.2, the dynamic shear moduli being measured at 60° C. during a temperature sweep at an imposed stress of 0.7 MPa and at a frequency of 10 Hz.

This ratio of moduli between the lateral portions and the central portion of the tread enables the lateral portions to stiffen the tread and the crown of the tyre. This improves the handling of the tyre.

Preferentially, K is less than 2.5 and very preferentially less than or equal to 1.5.

The dynamic shear modulus of the lateral portions is preferably between 1 and 2.5 MPa.

Above such a ratio or such a dynamic modulus value, the grip performance of the tyre may be reduced.

### DESCRIPTION OF THE FIGURES

The features of the invention will be better understood with the aid of the appended drawings in which:

FIG. 1 very schematically shows (without being drawn to any particular scale) a radial cross section through the crown of a tyre in accordance with one embodiment of the invention;

FIG. 2 shows an embodiment variant of the tyre crown from FIG. 1;

FIG. 3 shows another embodiment of a tyre crown according to the invention.

### DETAILED DESCRIPTION OF THE INVENTION

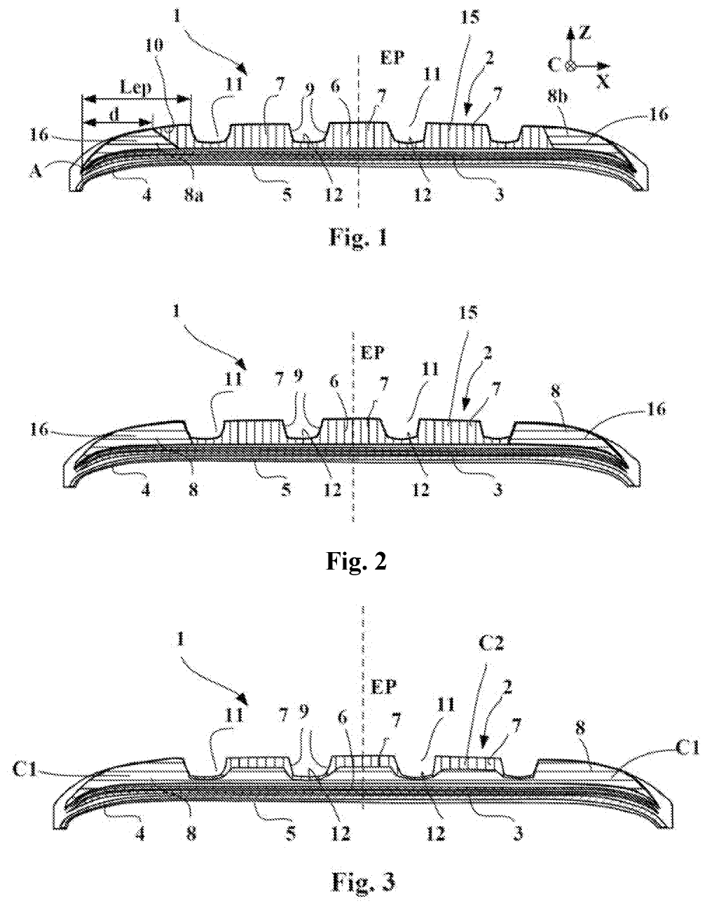

FIG. 1 schematically shows a radial cross section through the crown 2 of a pneumatic tyre or tyre 1 according to one embodiment of the invention.

FIG. 1 also indicates the axial X, circumferential C and radial Z directions and also the median plane EP (plane perpendicular to the axis of rotation of the tyre which is situated halfway between the two beads and passes through the middle of the crown reinforcement of the tyre).

This tyre 1 comprises a crown 2 reinforced by a crown reinforcement or belt 3, two sidewalls (not shown) and two beads (not shown), each of these beads being reinforced with a bead wire (not shown). The crown reinforcement 3 is surmounted radially externally by a rubber tread 7. A carcass reinforcement 4 is positioned radially inside the crown reinforcement 3, is anchored in each bead and extends from one bead to the other. In a manner known per se, the carcass reinforcement 4 is made up of at least one ply reinforced by what are known as “radial” cords, for example of textile or metal, that is to say that these cords are disposed virtually parallel to one another and extend from one bead to the other so as to form an angle of between 80° and 90° with the median circumferential plane EP. A airtight layer 5 extends from one bead to the other radially on the inside with respect to the carcass reinforcement 4.

The cross section from FIG. 1 of the tread 6 illustrates five tread pattern elements, three in the central portion of the crown, the centre tread pattern elements 7 and two axially laterally, at the shoulders of the crown, the shoulder tread pattern elements 8. Each groove has two opposite lateral faces 9 of the adjacent tread pattern elements and also a groove base 12. In the example of FIG. 1, the central portion 15 of the tread extends axially on either side of the median plane EP beyond the circumferential grooves 11. The two lateral portions 16 of the tread 6 therefore constitute the axially outer portions of the two shoulder tread pattern elements 8.

Taking, as reference, point A which corresponds to the axial end of the crown reinforcement, the axial width of the shoulder tread pattern element 8 is Lep. The axial width on the contact face 10 of the shoulder tread pattern element 8 when new is d. Preferably, the d/Lep ratio is greater than ⅓. In the example shown on the left of FIG. 1, shoulder tread pattern element 8a, this ratio increases with the wear of the tread. In the variant illustrated on the right of FIG. 1, shoulder tread pattern element 8b, the partition between the central portion and the lateral portion is such that it moves closer to the median plane when it moves radially away from the axis of rotation. This variant makes it possible to maintain a shear stiffness of the shoulder tread pattern element 8b which is substantially constant as the tread wears.

According to a second variant, illustrated in FIG. 2, the central portion of the tread extends axially to the axially outermost circumferential grooves 11, on either side of the median plane EP of the tyre. In this variant, it is the whole of the shoulder tread pattern elements 8 which constitutes the lateral portions of the tread. It is advantageous for the base of the grooves to be part of the central portion of the tread because the rubber composition of the central portion has a lower dynamic stiffness than that of the lateral portions and the moulding of the bases of the grooves is more robust. This is what is illustrated in FIG. 2.

According to the embodiment illustrated in FIG. 3, the tread comprises a radially inner first layer C1 and a radially outer second layer C2. The first layer C1 is continuous from the tread pattern element 8a to the tread pattern element 8b over the entire axial width of the tread. In this example, the lateral portions of the first layer C1 constitute the lateral portions 16 and the second layer C2 constitutes the central portion 15 of the tread.

FIGS. 1 to 3 clearly illustrate the role of stiffening the tread and the crown of the tyre when the dynamic modulus ratio between the two rubber mixtures of the lateral portions and of the central portion is greater than 1.1 and preferably greater than 1.2. It is preferable not to exceed a ratio of 2.5, and very preferentially 1.5, so as not to degrade the grip of the tyre when the tread surface is due in large part to the lateral portions.

In what follows, any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b). The abbreviation “phr” means parts by weight per hundred parts by weight of elastomer (of the total of the elastomers if several elastomers are present).

In the present patent application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of the monomer units of the copolymer, that is to say on the basis of all of the monomer units of the elastomer.

The compounds mentioned in the description may be of fossil or biobased origin. In the latter case, they can result, partially or completely, from biomass or be obtained from renewable starting materials resulting from biomass. Elastomers, plasticizers, fillers and the like are notably concerned.

The copolymer of ethylene and of 1,3-diene which is useful for the purposes of the invention is a preferably random elastomer which comprises ethylene units resulting from the polymerization of ethylene. In a known way, the expression “ethylene unit” refers to the —(CH₂—CH₂)— unit resulting from the insertion of ethylene into the elastomer chain. In the copolymer of ethylene and of 1,3-diene, the ethylene units represent more than 50 mol % of the monomer units of the copolymer. Preferably, the ethylene units in the copolymer represent more than 60 mol %, advantageously more than 70 mol % of the monomer units of the copolymer. According to any one of the embodiments of the invention, including the preferential variants thereof, the highly saturated diene elastomer preferentially comprises at most 90 mol % of ethylene unit.

The copolymer which is useful for the purposes of the invention, also referred to below under the name “highly saturated diene elastomer”, also comprises 1,3-diene units resulting from the polymerization of a 1,3-diene, the 1,3-diene being 1,3-butadiene or isoprene. In a known manner, the term “1,3-diene unit” refers to units resulting from the insertion of the 1,3-diene via a 1,4 addition, a 1,2 addition or a 3,4 addition in the case of isoprene. Preferably, the 1,3-diene is 1,3-butadiene.

According to a first embodiment of the invention, the copolymer of ethylene and of a 1,3-diene contains units of formula (I). The presence of a saturated 6-membered cyclic unit, 1,2-cyclohexanediyl, of formula (I) as a monomer unit in the copolymer can result from a series of very particular insertions of ethylene and 1,3-butadiene in the polymer chain during its growth.

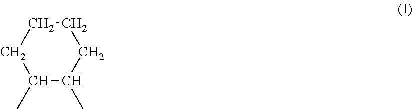

According to a second preferential embodiment of the invention, the copolymer of ethylene and of a 1,3-diene contains units of formula (II-1) or (II-2).

—CH₂—CH(CH═CH₂)— (II-1)

—CH₂—CH(CMe═CH₂) (II-2)

According to a third preferential embodiment of the invention, the copolymer of ethylene and of a 1,3-diene contains units of formula (I) and of formula (II-1).

According to a fourth embodiment of the invention, the highly saturated diene elastomer is devoid of units of formula (I). According to this fourth embodiment, the copolymer of ethylene and of a 1,3-diene preferably contains units of formula (II-1) or (II-2).

Preferably, the highly saturated diene elastomer contains units resulting from the insertion of the 1,3-diene by a 1,4 addition, that is to say units of formula —CH₂—CH═CH—CH₂— when the 1,3-diene is 1,3-butadiene, or of formula —CH₂—CMe═C—CH₂— when the 1,3-diene is isoprene.

When the highly saturated diene elastomer comprises units of formula (I) or units of formula (II-1) or else comprises units of formula (I) and units of formula (II-1), the molar percentages of units of formula (I) and of units of formula (II-1) in the highly saturated diene elastomer, respectively o and p, preferably satisfy the following equation (eq. 1), more preferentially the equation (eq. 2), o and p being calculated on the basis of all the monomer units of the highly saturated diene elastomer.

0<o+p≤25 (eq. 1)

0<o+p<20 (eq. 2)

According to the first embodiment, according to the second embodiment of the invention, according to the third embodiment and according to the fourth embodiment, including the preferential variants thereof, the highly saturated diene elastomer is preferentially a random copolymer.

The highly saturated diene elastomer, in particular according to the first embodiment, according to the second embodiment, according to the third embodiment and according to the fourth embodiment, can be obtained according to various synthesis methods known to those skilled in the art, in particular as a function of the intended microstructure of the highly saturated diene elastomer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in documents EP 1 092 731, WO 2004/035639, WO 2007/054223 and WO 2007/054224 in the name of the applicant. The highly saturated diene elastomer, including the case when it is random, may also be prepared via a process using a catalytic system of preformed type such as those described in documents WO 2017/093654 A1, WO 2018/020122 A1 and WO 2018/020123 A1.

The highly saturated diene elastomer may consist of a mixture of copolymers of ethylene and of 1,3-diene which differ from each other by virtue of their microstructures or their macrostructures.

According to the first embodiment of the invention, according to the second embodiment of the invention, according to the third embodiment and according to the fourth embodiment, the highly saturated diene elastomer is preferably a copolymer of ethylene and of 1,3-butadiene, more preferentially a random copolymer of ethylene and of 1,3-butadiene.

According to one particular embodiment of the invention, the copolymer of ethylene and of a 1,3-diene bears at the chain end a functional group F1 which is a silanol or alkoxysilane function. This embodiment is also favourable to improving the rolling resistance.

According to this embodiment, the silanol or alkoxysilane function is located at the end of the chain of the highly saturated diene elastomer. In the present application, the alkoxysilane or silanol function borne at one of the ends is referred to in the present application by the name the functional group F1. Preferably, it is attached directly via a covalent bond to the terminal unit of the highly saturated diene elastomer, which means to say that the silicon atom of the function is directly bonded, covalently, to a carbon atom of the terminal unit of the highly saturated diene elastomer. The terminal unit to which the functional group F1 is directly attached preferably consists of a methylene bonded to an ethylene unit or to a 1,2-cyclohexanediyl unit, of formula (I), the Si atom being bonded to the methylene. A terminal unit is understood to mean the last unit inserted in the copolymer chain by copolymerization, which unit is preceded by the penultimate unit, which is itself preceded by the antepenultimate unit.

According to a first alternative form of this embodiment, the functional group F1 is of formula (III-a)

Si(OR¹)_{3-f}(R²)_{f} (III-a)

the R1 symbols, which may be identical or different, representing an alkyl,
the R2 symbols, which may be identical or different, representing a hydrogen atom, a hydrocarbon chain or a hydrocarbon chain substituted by a chemical function F2;
f being an integer ranging from 0 to 2.

In the formula (III-a), the R1 symbols are preferentially an alkyl having at most 6 carbon atoms, more preferentially a methyl or an ethyl, more preferentially still a methyl.

If 3-f is greater than 1, the R1 symbols are advantageously identical, in particular methyl or ethyl, more particularly methyl.

According to a second variant of this embodiment, the functional group F1 is of formula (III-b)

Si(OH)(R²)₂. (III-b)

the R2 symbols, which may be identical or different, representing a hydrogen atom, a hydrocarbon chain or a hydrocarbon chain substituted by a chemical function F2.

Among the hydrocarbon chains represented by the R2 symbols in formulae (III-a) and (III-b), mention may be made of alkyls, in particular those having 1 to 6 carbon atoms, preferentially methyl or ethyl, more preferentially methyl.

Among the hydrocarbon chains substituted by a chemical function F2 represented by the R2 symbols in the formulae (III-a) and (III-b), mention may be made of alkanediyl chains, in particular those comprising at most 6 carbon atoms, very particularly the 1,3-propanediyl group, the alkanediyl group bearing a substituent, the chemical function F2, in other words one valence of the alkanediyl chain for the function F2, the other valence for the silicon atom of the silanol or alkoxysilane function.

In formulae (III-a) and (III-b), a chemical function F2 is understood to mean a group which is different from a saturated hydrocarbon group and which may participate in chemical reactions. Among the chemical functions which may be suitable, mention may be made of the ether function, the thioether function, the primary, secondary or tertiary amine function, the thiol function, the silyl function. The primary or secondary amine or thiol functions may be protected or may not be protected. The protective group for the amine and thiol functions is for example a silyl group, in particular a trimethylsilyl or tert-butyldimethylsilyl group. Preferably, the chemical function F2 is a primary, secondary or tertiary amine function or a thiol function, the primary or secondary amine or thiol function being protected by a protecting group or being unprotected.

Preferably, the R2 symbols, which may be identical or different, represent an alkyl having at most 6 carbon atoms or an alkanediyl chain having at most 6 carbon atoms and substituted by a chemical function F2 in formulae (III-a) and (III-b).

Mention may be made, as functional group F1, of the dimethoxymethylsilyl, dimethoxyethylsilyl, diethoxymethylsilyl, diethoxyethylsilyl, 3-(N,N-dimethylamino)propyldimethoxysilyl, 3-(N,N-dimethylamino)propyldiethoxysilyl, 3-aminopropyldimethoxysilyl, 3-aminopropyldiethoxysilyl, 3-thiopropyldimethoxysilyl, 3-thiopropyldiethoxysilyl, methoxydimethylsilyl, methoxydiethylsilyl, ethoxydimethylsilyl, ethoxydiethylsilyl, 3-(N,N-dimethylamino)propylmethoxymethylsilyl, 3-(N,N-dimethylamino)propylmethoxyethylsilyl, 3-(N,N-dimethylamino)propylethoxymethylsilyl, 3-(N,N-dimethylamino)propylethoxyethylsilyl, 3-aminopropylmethoxymethylsilyl, 3-aminopropylmethoxyethylsilyl, 3-aminopropylethoxymethylsilyl, 3-aminopropylethoxyethylsilyl, 3-thiopropylmethoxymethylsilyl, 3-thiopropylethoxymethylsilyl, 3-thiopropylmethoxyethylsilyl and 3-thiopropylethoxyethylsilyl groups.

Mention may also be made, as functional group F1, of the silanol form of the functional groups mentioned above which contain one and only one ethoxy or methoxy function, it being possible for the silanol form to be obtained by hydrolysis of the ethoxy or methoxy function. In this regard, the dimethylsilanol, diethylsilanol, 3-(N,N-dimethylamino)propylmethylsilanol, 3-(N,N-dimethylamino)propylethylsilanol, 3-aminopropylmethylsilanol, 3-aminopropylethylsilanol, 3-thiopropylethylsilanol and 3-thiopropylmethylsilanol groups are suitable.

Mention may also be made, as functional group F1, of the functional groups whether they are in the alkoxy or silanol form, which have been mentioned above and which comprise an amine or thiol function in a form protected by a silyl group, in particular trimethylsilyl or tert-butyldimethylsilyl group.

Preferably, the functional group F1 is of formula (III-a) in which f is equal to 1. For this preferential alternative form, the groups for which R1 is a methyl or an ethyl, such as for example the dimethoxymethylsilyl, dimethoxyethylsilyl, diethoxymethylsilyl, diethoxyethylsilyl, 3-(N,N-dimethylamino)propyldimethoxysilyl, 3-(N,N-dimethylamino)propyldiethoxysilyl, 3-aminopropyldimethoxysilyl, 3-aminopropyldiethoxysilyl, 3-thiopropyldimethoxysilyl and 3-thiopropyldiethoxysilyl groups, are very particularly suitable. Also suitable are the protected forms of the amine or thiol function of the last 4 functional groups mentioned in the preceding list, protected by a silyl group, in particular trimethylsilyl or tert-butyldimethylsilyl group.

More preferentially, the functional group F1 is of formula (III-a) in which f is equal to 1 and R1 is a methyl. For this more preferential alternative form, the dimethoxymethylsilyl, dimethoxyethylsilyl, 3-(N,N-dimethylamino)propyldimethoxysilyl, 3-aminopropyldimethoxysilyl and 3-thiopropyldimethoxysilyl groups, and also the protected forms of the amine or thiol function of 3-aminopropyldimethoxysilyl or 3-thiopropyldimethoxysilyl, protected by a trimethylsilyl or a tert-butyldimethylsilyl, are very particularly suitable.

The copolymer of ethylene and of a 1,3-diene which bears at the chain end a functional group F1, silanol or alkoxysilane function, can be prepared by the process described in the patent application filed under number PCT/FR2018/051305 or in the patent application filed under number PCT/FR2018/051306, which process comprises steps (a) and (b), and where appropriate, step (c) below:

(a) the copolymerization of a monomer mixture in the presence of a catalytic system comprising an organomagnesium compound and a metallocene;

(b) the reaction of a functionalizing agent with the polymer obtained in step (a);

(c) where appropriate, a hydrolysis reaction.

Step (a) is common to the copolymerization step carried out to prepare the non-functional homologous copolymers described above, with the only difference being that the copolymerization reaction is followed by a reaction for functionalization of the copolymer, step (b).

Step (b) consists in reacting a functionalizing agent with the copolymer obtained in step (a) in order to functionalize the copolymer at the chain end. The functionalizing agent is a compound of formula (IV),

Si(Fc¹)_{4-g}(Rc²)_{g} (IV)
the Fc1 symbols, which may be identical or different, representing an alkoxy group or a halogen atom;
the Rc2 symbols, which may be identical or different, representing a hydrogen atom, a hydrocarbon chain or a hydrocarbon chain substituted by a chemical function Fc2;
g being an integer ranging from 0 to 2.

When the Fc1 symbol represents an alkoxy group, the alkoxy group is preferably methoxy or ethoxy. When the Fc1 symbol represents a halogen atom, the halogen atom is preferably chlorine.

When the Fc1 symbol represents an alkoxy group, the alkoxy group is preferably methoxy or ethoxy. When the Fc1 symbol represents a halogen atom, the halogen atom is preferably chlorine.

The functionalizing agent can be of formula (IV-1), of formula (IV-2), of formula (IV-3) or of formula (IV-4),

MeOSi(Fc¹)_{3-g}(Rc²)_{g} (IV-1)

(MeO)₂Si(Fc1)_{2-g}(Rc²) (IV-2)

(MeO)₃Si(Fc¹)_{1-g}(Rc²)_{g} (IV-3)

(MeO)₃SiRc² (IV-4),
in which the Fc1 and Rc2 symbols are as defined in formula (IV);
for formulae (IV-1) and (IV-2), g being an integer ranging from 0 to 2;
for formula (IV-3), g being an integer ranging from 0 to 1.

Among the hydrocarbon chains represented by the Rc2 symbols in formulae (III), (IV-1), (IV-2), (IV-3) and (IV-4), mention may be made of alkyls, preferably alkyls having at most 6 carbon atoms, more preferentially methyl or ethyl, better still methyl.

Among the hydrocarbon chains substituted by a chemical function Fc2 which are represented by the Rc2 symbols in formulae (IV), (IV-1), (IV-2), (IV-3) and (IV-4), mention may be made of alkanediyl chains, preferably those comprising at most 6 carbon atoms, more preferentially the 1,3-propanediyl group, the alkanediyl group bearing a substituent, the chemical function Fc2, in other words one valence of the alkanediyl chain for the function F2, the other valence for the silicon atom of the silanol or alkoxysilane function.

In the formulae (IV), (IV-1), (IV-2), (IV-3) and (IV-4), a chemical function is understood to mean a group which is different from a saturated hydrocarbon group and which may participate in chemical reactions. Those skilled in the art understand that the chemical function Fc2 is a group that is chemically inert with respect to the chemical species present in the polymerization medium. The chemical function Fc2 may be in a protected form, such as for example in the case of the primary amine, secondary amine or thiol function. Mention may be made, as chemical function Fc2, of the ether, thioether, protected primary amine, protected secondary amine, tertiary amine, protected thiol, and silyl functions. Preferably, the chemical function Fc2 is a protected primary amine function, a protected secondary amine function, a tertiary amine function or a protected thiol function.

As protective groups for the primary amine, secondary amine and thiol functions, mention may be made of silyl groups, for example the trimethylsilyl and tert-butyldimethylsilyl groups.

g is preferably other than 0, which means that the functionalizing agent comprises at least one Si—Rc2 bond.

Mention may be made, as functionalizing agent, of the compounds dimethoxydimethylsilane, diethoxydimethylsilane, dimethoxydiethylsilane, diethoxydiethylsilane, (N,N-dimethyl-3-aminopropyl)methyldimethoxysilane, (N,N-dimethyl-3-aminopropyl)methyldiethoxysilane, (N,N-dimethyl-3-aminopropypethyldimethoxysilane, (N,N-dimethyl-3-aminopropyl)ethyldiethoxysilane, 3-methoxy-3,8,8,9,9-pentamethyl-2-oxa-7-thia-3,8-disiladecane, trimethoxymethylsilane, triethoxymethylsilane, trimethoxyethylsilane, triethoxyethylsilane, (N,N-dimethylaminopropyl)trimethoxysilane, (N,N-dimethylaminopropyl)triethoxysilane, (N-(3-trimethoxysilyl)propyl)-N-(trimethylsilyl)silanamine, (N-(3-triethoxysilyl)propyl)-N-(trimethylsilyl)silanamine and 3,3-dimethoxy-8,8,9,9-tetramethyl-2-oxa-7-thia-3,8-disiladecane, preferably dimethoxydimethylsilane, dimethoxydiethylsilane, (N,N-dimethyl-3-aminopropyl)methyldimethoxysilane, (N,N-dimethyl-3-aminopropypethyldimethoxysilane, 3-methoxy-3,8,8,9,9-pentamethyl-2-oxa-7-thia-3,8-disiladecanetrimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane, more preferentially trimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane.

The functionalizing agent is typically added to the polymerization medium resulting from step (a). It is typically added to the polymerization medium at a degree of conversion of the monomers chosen by a person skilled in the art depending on the desired macrostructure of the elastomer. Since step (a) is generally carried out under ethylene pressure, a degassing of the polymerization reactor may be carried out before the addition of the functionalizing agent. The functionalizing agent is added under inert and anhydrous conditions to the polymerization medium, maintained at the polymerization temperature. Use is typically made of from 0.25 to 10 mol of functionalizing agent per 1 mol of cocatalyst, preferably of from 2 to 4 mol of functionalizing agent per 1 mol of cocatalyst.

The functionalizing agent is bought into contact with the polymerization medium for a time sufficient to enable the functionalization reaction. This contact time is judiciously chosen by a person skilled in the art as a function of the concentration of the reaction medium and of the temperature of the reaction medium. Typically, the functionalization reaction is carried out under stirring, at a temperature ranging from 17° C. to 80° C., for 0.01 to 24 hours.

Once functionalized, the elastomer may be recovered, in particular by isolating it from the reaction medium. The techniques for separating the elastomer from the reaction medium are well known to a person skilled in the art and are chosen by a person skilled in the art depending on the amount of elastomer to be separated, its macrostructure and the tools available to a person skilled in the art. Mention may be made, for example, of the techniques of coagulating the elastomer in a solvent such as methanol, the techniques of evaporating the solvent of the reaction medium and the residual monomers, for example under reduced pressure.

When the functionalizing agent is of formula (IV), (IV-1) or (IV-2) and g is equal to 2, step (b) may be followed by a hydrolysis reaction in order to form an elastomer bearing a silanol function at the chain end. The hydrolysis may be carried out by a step of stripping of the solution containing the elastomer at the end of step (b), in a manner known to a person skilled in the art.

When the functionalizing agent is of formula (IV), (IV-1), (IV-2), (IV-3) or (IV-4), when g is other than 0 and when Rc2 represents a hydrocarbon chain substituted by a function Fc2 in a protected form, step (b) may also be followed by a hydrolysis reaction in order to deprotect the function at the end of the chain of the elastomer. The hydrolysis reaction, step of deprotecting the function, is generally carried out in an acid or basic medium depending on the chemical nature of the function to be deprotected. For example, a silyl group, in particular trimethylsilyl or tert-butyldimethylsilyl group, which protects an amine or thiol function may be hydrolysed in an acid or basic medium in a manner known to a person skilled in the art. The choice of the deprotection conditions is judiciously made by a person skilled in the art taking into account the chemical structure of the substrate to be deprotected.

Step (c) is an optional step depending on whether or not it is desired to convert the functional group into a silanol function or whether or not it is desired to deprotect the protected function. Preferentially, step (c) is carried out before separating the elastomer from the reaction medium at the end of step (b) or else at the same time as this separation step.

Whether or not it bears a silanol or alkoxysilane function, the content of the copolymer of ethylene and of a 1,3-diene is greater than 50 phr, preferentially greater than 70 phr. The remainder to 100 phr can be any diene elastomer, for example a 1,3-butadiene homopolymer or copolymer or else an isoprene homopolymer or copolymer. Advantageously, the content of the copolymer of ethylene and of a 1,3-diene is 100 phr. A high content of the copolymer in the rubber composition is even more favourable for the performance compromise between rolling resistance, wear resistance and grip.

Another essential feature of the rubber composition of the lateral portions is that it comprises a reinforcing filler and a plasticizing system. The plasticizing system is preferably hydrocarbon-based.

Advantageously, the reinforcing filler comprises a silica.

A reinforcing filler typically consists of nanoparticles of which the mean (weight-average) size is less than a micrometre, generally less than 500 nm, usually between 20 and 200 nm, in particular and more preferentially between 20 and 150 nm.

The content of reinforcing filler in the rubber composition of the lateral portions is advantageously greater than or equal to 35 phr and less than or equal to 100 phr, preferably greater than or equal to 50 phr and less than or equal to 100 phr. Preferably, the silica represents more than 50% by weight of the reinforcing filler. More preferentially, the silica represents more than 85% by weight of the reinforcing filler.

The silica used can be any reinforcing silica known to a person skilled in the art, in particular any precipitated or fumed silica exhibiting a BET specific surface area and a CTAB specific surface area both of less than 450 m²/g, preferably within a range extending from 30 to 400 m²/g, in particular from 60 to 300 m²/g. In the present disclosure, the BET specific surface area is determined by gas adsorption using the Brunauer-Emmett-Teller method described in “The Journal of the American Chemical Society”, (Vol. 60, page 309, February 1938), and more specifically according to a method derived from standard NF ISO 5794-1, appendix E, of June 2010 [multipoint (5 point) volumetric method—gas:nitrogen—degassing under vacuum: one hour at 160° C.—relative pressure p/po range: 0.05 to 0.17].

The CTAB specific surface area values were determined according to the standard NF ISO 5794-1, appendix G of June 2010. The process is based on the adsorption of CTAB (N-hexadecyl-N,N,N-trimethylammonium bromide) on the “external” surface of the reinforcing filler.

Any type of precipitated silica, in particular highly dispersible precipitated silicas (referred to as “HDS” for “highly dispersible” or “highly dispersible silica”), can be used. These precipitated silicas, which may or may not be highly dispersible, are well known to those skilled in the art. Mention may be made, for example, of the silicas described in applications WO 03/016215-A1 and WO 03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The reinforcing filler may comprise any type of “reinforcing” filler other than silica, known for its capacity to reinforce a rubber composition which can be used in particular for the manufacture of tyres, for example a carbon black. All carbon blacks, in particular the blacks conventionally used in tyres or their treads, are suitable as carbon blacks. Among the latter, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used.

Preferably, the carbon black is used at a content of less than or equal to 20 phr, more preferentially less than or equal to 10 phr (for example the carbon black content may be in a range extending from 0.5 to 20 phr, in particular extending from 1 to 10 phr).

Advantageously, the carbon black content in the rubber composition is less than or equal to 5 phr. Within the intervals indicated, the colouring properties (black pigmenting agent) and UV-stabilizing properties of the carbon blacks are beneficial, without, moreover, adversely affecting the typical performance qualities contributed by the silica.

To couple the reinforcing inorganic filler, in this case silica, to the elastomer, it is possible to use, in a well-known manner, an at least bifunctional coupling agent (or bonding agent) intended to ensure a sufficient connection, of chemical and/or physical nature, between the inorganic filler (surface of its particles) and the elastomer, in which case the rubber composition of the lateral portions comprises a coupling agent for binding the silica to the elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the elastomer.

Use is in particular made of silane polysulfides, referred to as “symmetrical” or “asymmetrical” depending on their specific structure, as described, for example, in applications WO 03/002648-A1 (or US 2005/016651-A1) and WO 03/002649-A1 (or US 2005/016650-A1). Suitable in particular, without the definition below being limiting, are silane polysulfides corresponding to general formula (V) below:

A—A—Sₓ—A—Z (V),

in which:
x is an integer from 2 to 8 (preferably from 2 to 5);
the A symbols, which may be identical or different, represent a divalent hydrocarbon radical (preferably a C₁-C₁₈ alkylene group or a C₆-C₁₂ arylene group, more particularly a C₁-C₁₀ alkylene, notably a C₁-C₄ alkylene, in particular propylene);
the Z symbols, which may be identical or different, correspond to one of the three formulae below:

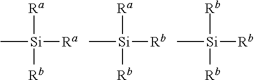

in which:
the Ra radicals, which are substituted or unsubstituted and identical to or different from one another, represent a C₁-C₁₈ alkyl group, a C₅-C₁₈ cycloalkyl group or a C₆-C₁₈ aryl group (preferably C₁-C₆ alkyl, cyclohexyl or phenyl groups, notably C₁-C₄ alkyl groups, more particularly methyl and/or ethyl);
the Rb radicals, which are substituted or unsubstituted and identical to or different from one another, represent a C₁-C₁₈ alkoxy group or a C₅-C₁₈ cycloalkoxy group (preferably a group chosen from C₁-C₈ alkoxys and C₅-C₈ cycloalkoxys, even more preferentially a group chosen from C₁-C₄ alkoxys, in particular methoxy and ethoxy), or a hydroxyl group, or such that two Rb radicals represent a C₃-C₁₈ dialkoxy group.

In the case of a mixture of alkoxysilane polysulfides corresponding to the above formula (V), in particular normal commercially available mixtures, the mean value of the “x” indices is a fractional number preferably within a range extending from 2 to 5, more preferentially of approximately 4.

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂ sold under the name Si69 by Evonik or bis(triethoxysilylpropyl) disulfide, abbreviated to TESPD, of formula [(C₂H₅O)₃Si(CH₂)₃S]₂ sold under the name Si75 by Evonik. Mention will also be made, as preferential examples, of bis(mono(C₁-C₄)alkoxydi(C₁-C₄)alkylsilylpropyl) polysulfides (in particular disulfides, trisulfides or tetrasulfides), more particularly bis(monoethoxydimethylsilylpropyl) tetrasulfide, such as described in the abovementioned patent application WO02/083782-A1 (or U.S. Pat. No. 7,217,751-B2).

Of course, use might also be made of mixtures of the coupling agents described above.

The content of coupling agent in the rubber composition of the lateral portions is advantageously less than or equal to 25 phr, it being understood that it is generally desirable to use as little as possible thereof. Typically, the content of coupling agent represents from 0.5% to 15% by weight, with respect to the amount of reinforcing inorganic filler. Its content is preferentially within a range extending from 0.5 to 20 phr, more preferentially within a range extending from 3 to 15 phr. This content is easily adjusted by a person skilled in the art according to the content of reinforcing inorganic filler used in the composition of the lateral portions of the tread of the tyre of the invention.

Another essential feature of the rubber composition of the lateral portions is that it comprises a plasticizing system. This plasticizing system advantageously comprises a hydrocarbon plasticizing resin and a hydrocarbon liquid plasticizing agent, it being understood that the total content of hydrocarbon plasticizing resin and hydrocarbon liquid plasticizing agent is greater than 10 phr and less than or equal to 80 phr, preferably greater than or equal to equal to 30 phr and less than or equal to 80 phr.

Hydrocarbon resins, also known as hydrocarbon plasticizing resins, are polymers well known to those skilled in the art, essentially based on carbon and hydrogen but which can comprise other types of atoms, for example oxygen, which can be used in particular as plasticizing agents or tackifying agents in polymer matrices. They are by nature at least partially miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, VCH, 1997, ISBN 3-527-28617-9), Chapter 5 of which is devoted to their applications, notably in the tyre rubber field (5.5. “Rubber Tires and Mechanical Goods”). In a known way, these hydrocarbon resins can also be described as thermoplastic resins in the sense that they soften when heated and can thus be moulded. The softening point of the hydrocarbon resins is measured according to standard ISO 4625 (“Ring and Ball” method). The Tg is measured according to standard ASTM D3418 (1999). The macrostructure (Mw, Mn and PDI) of the hydrocarbon resin is determined by size exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

The hydrocarbon resins may be aliphatic or aromatic or else of the aliphatic/aromatic type, that is to say based on aliphatic and/or aromatic monomers. They can be natural or synthetic and may or may not be petroleum-based (if such is the case, they are also known under the name of petroleum resins). Preferably, the hydrocarbon plasticizing resin has a glass transition temperature above 20° C.

Advantageously, the hydrocarbon plasticizing resin has at least any one of the following features, more preferentially all of them:
a Tg above 30° C.;
a number-average molecular weight (Mn) of between 300 and 2000 g/mol, more preferentially between 400 and 1500 g/mol;
a polydispersity index (PDI) of less than 3, more preferably of less than 2 (as a reminder: PDI=Mw/Mn with Mw being the weight-average molecular weight).

Preferably, the hydrocarbon plasticizing resin is selected from the group consisting of cyclopentadiene homopolymer resins, cyclopentadiene copolymer resins, dicyclopentadiene homopolymer resins, dicyclopentadiene copolymer resins, terpene homopolymer resins, terpene copolymer resins, C5-cut homopolymer resins, C5-cut copolymer resins, C9-cut homopolymer resins, C9-cut copolymer resins, hydrogenated cyclopentadiene homopolymer resins and hydrogenated cyclopentadiene copolymer resins.

More preferentially, the hydrocarbon plasticizing resin is a C9-cut copolymer resin or a dicyclopentadiene copolymer resin, which is hydrogenated or non-hydrogenated. By way of example, mention may very particularly be made of C9-cut copolymer resins and hydrogenated dicyclopentadiene copolymer resins.

Hydrocarbon liquid plasticizing agents are known to soften a rubber composition by diluting the elastomer and the reinforcing filler of the rubber composition. Their Tg is typically below −20° C., preferentially below −40° C. Any hydrocarbon extender oil or any hydrocarbon liquid plasticizing agent for its plasticizing properties with respect to diene elastomers can be used. At ambient temperature (23° C.), these plasticizers or these oils, which are more or less viscous, are liquids (that is to say, as a reminder, substances which have the ability to eventually take on the shape of their container), as opposed especially to hydrocarbon plasticizing resins which are by nature solid at ambient temperature.

As hydrocarbon liquid plasticizing agents, mention may be made of liquid diene polymers, polyolefin oils, naphthenic oils, paraffinic oils, DAE oils, MES (Medium Extracted Solvate) oils, TDAE (Treated Distillate Aromatic Extract) oils, RAE (Residual Aromatic

Extract) oils, TRAE (Treated Residual Aromatic Extract) oils and SRAE (Safety Residual Aromatic Extract) oils, mineral oils, and mixtures of these compounds.

Preferably, the hydrocarbon liquid placticizing agent is selected from the group consisting of liquid diene polymers, aliphatic polyolefin oils, paraffinic oils, MES oils, TDAE oils, TRAE oils, SRAE oils, mineral oils and mixtures thereof. More preferentially, the hydrocarbon liquid plasticizing agent is a liquid diene polymer, an aliphatic polyolefin oil, a paraffinic oil, an MES oil or mixtures thereof.

According to one particular embodiment of the invention, the weight ratio between the content of hydrocarbon plasticizing resin and the total content of hydrocarbon plasticizing resin and of hydrocarbon liquid plasticizing agent is greater than 0.4. This particular embodiment is also favourable to improving the handling of a tyre, the tread of which comprises such a rubber composition.

The plasticizing system may contain, generally in a small amount, another plasticizing agent other than the hydrocarbon plasticizing resin and the hydrocarbon liquid plasticizing agent useful for the needs of the invention, as long as the desired performance compromise is not detrimentally modified. This other plasticizing agent can be, for example, a processing aid traditionally used in a small amount to promote, for example, the dispersion of the silica. According to any one of the embodiments of the invention, the hydrocarbon plasticizing resin and the hydrocarbon liquid plasticizing agent advantageously represent substantially the main part of the plasticizing system, that is to say the ratio between the content of hydrocarbon plasticizing resin and hydrocarbon liquid plasticizing agent to the content of the total plasticizing system in the rubber composition of the lateral portions, the contents being expressed in phr, is greater than 0.8, very advantageously greater than 0.9.

According to an advantageous feature of the rubber composition of the lateral portions, the weight ratio between the content of reinforcing filler and the total content of hydrocarbon plasticizing resin and of hydrocarbon liquid plasticizing agent is greater than or equal to 1.1, and preferably greater than 1.2, the contents being expressed in phr. The composition of the lateral portions according to this particular embodiment provides stiffening within the tread, which makes it possible to improve the handling of a tyre, the tread of which has a high-grip surface due to the use of a highly deformable rubber composition intended to come into contact with the ground.

The rubber composition of the lateral portions can also comprise all or some of the usual additives customarily used in elastomer compositions intended for the manufacture of tyres, in particular pigments, protective agents such as anti-ozone waxes, chemical anti-ozonants, antioxidants, a crosslinking system which can be based either on sulfur or on sulfur donors and/or on peroxide and/or on bismaleimides, vulcanization accelerators or retarders, or vulcanization activators.

The actual crosslinking system is preferentially a vulcanization system, that is to say based on sulfur and on a primary vulcanization accelerator. The sulfur is typically provided in the form of molecular sulfur or of a sulfur-donating agent, preferably in molecular form. Sulfur in molecular form is also referred to by the term “molecular sulfur”. The term “sulfur donor” means any compound which releases sulfur atoms, optionally combined in the form of a polysulfide chain, which are capable of inserting into the polysulfide chains formed during the vulcanization and bridging the elastomer chains. Various known secondary vulcanization accelerators or vulcanization activators, such as zinc oxide, stearic acid, guanidine derivatives (in particular diphenylguanidine), and the like, are added to the vulcanization system, being incorporated during the first non-productive phase and/or during the productive phase. The sulfur content is preferably between 0.5 and 3.0 phr and the content of the primary accelerator is preferably between 0.5 and 5.0 phr. These preferential contents may apply to any one of the embodiments of the invention.

Use may be made, as (primary or secondary) vulcanization accelerator, of any compound that is capable of acting as accelerator of the vulcanization of diene elastomers in the presence of sulfur, notably accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators. As examples of primary accelerators, mention may notably be made of sulfenamide compounds such as N-cyclohexyl-2-benzothiazylsulfenamide (“CBS”), N,N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide. As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

The crosslinking (or curing), where appropriate the vulcanization, is carried out in a known manner at a temperature generally of between 130° C. and 200° C., for a sufficient time which may vary, for example, between 5 and 90 min, depending especially on the curing temperature, on the crosslinking system adopted and on the crosslinking kinetics of the composition in question.

The rubber composition, before crosslinking, may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first (non-productive) phase is carried out in a single thermomechanical step during which all the necessary constituents, the optional additional processing aids and various other additives, with the exception of the crosslinking system, are introduced into an appropriate mixer, such as a normal internal mixer. The total duration of the kneading, in this non-productive phase, is preferably between 1 and 15 min. After cooling of the mixture thus obtained during the first non-productive phase, the is then incorporated at low temperature, generally in an external mixer, such as an open mill; everything is then mixed (productive phase) for a few minutes, for example between 2 and 15 min.

The rubber composition can be calendered or extruded in the form of a sheet or of a slab, in particular for a laboratory characterization, or also in the form of a rubber semi-finished product (or profiled element) that can be used in a tyre. The composition may be either in the raw state (before crosslinking or vulcanization) or in the cured state (after crosslinking or vulcanization), may be a semi-finished product which can be used in a tyre.

Determination of the microstructure of the elastomers:

The microstructure of the elastomers is determined by ¹H NMR analysis, compensated for by the ¹³C NMR analysis when the resolution of the ¹H NMR spectra does not make it possible to assign and quantify all the entities. The measurements are performed using a Brüker 500 MHz NMR spectrometer at frequencies of 500.43 MHz for proton observation and 125.83 MHz for carbon observation.

For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The preparation of the insoluble samples is performed in rotors filled with the analysed material and a deuterated solvent enabling swelling, generally deuterated chloroform (CDCl3). The solvent used must always be deuterated and its chemical nature may be adapted by those skilled in the art. The amounts of material used are adjusted so as to obtain spectra of sufficient sensitivity and resolution.

The soluble samples are dissolved in a deuterated solvent (about 25 mg of elastomer in 1 mL), generally deuterated chloroform (CDCl3). The solvent or solvent blend used must always be deuterated and its chemical nature may be adapted by those skilled in the art.

In both cases (soluble sample or swollen sample):

A 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

The NMR measurements are performed at 25° C.

Determination of the Mooney viscosity:

The Mooney viscosity is measured using an oscillating consistometer as described in Standard ASTM D1646 (1999). The measurement is carried out according to the following principle: the sample, analysed in the uncured state (i.e., before curing), is moulded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. Mooney viscosity is expressed in “Mooney unit” (MU, with 1 MU=0.83 newton.metre).

The evaluation of the stiffness of the rubber compositions was evaluated by determining the dynamic shear modulus G*. The response of a sample of vulcanized composition subjected to a sinusoidal alternating shear stress at an imposed stress of 0.7 MPa and at a frequency of 10 Hz, during a temperature sweep, at a minimum temperature below the Tg of the elastomers of the compositions up to a maximum temperature above 100° C. is recorded; the values of G* are taken at the temperature of 60° C.

Six rubber compositions T1 and M1 to M5, the formulation details of which appear in Table 1, were prepared as follows:

The elastomers, the reinforcing fillers and the various other ingredients, with the exception of the sulfur and the vulcanization accelerator, are successively introduced into an internal mixer (final degree of filling: approximately 70% by volume), the initial vessel temperature of which is about 80° C. Thermomechanical working (non-productive phase) is then performed in one step, which lasts in total approximately 3 to 4 min, until a maximum “dropping” temperature of 165° C. is reached. The mixture thus obtained is recovered and cooled, and sulfur and the vulcanization accelerator are then incorporated on a mixer (homofinisher) at 30° C., the whole being kneaded (productive phase) for an appropriate time (for example approximately ten minutes).

The compositions thus obtained are then calendered either in the form of slabs (thickness 2 to 3 mm) or of thin sheets of rubber for the measurement of their physical or mechanical properties, or extruded to form for example a profiled element for a tyre.

Table 1 below describes a rubber composition T1 from the prior art, used as a mixture of the central portion of the tread, and also five compositions in accordance with the invention for mixtures of the lateral portions.

The five rubber compositions M1 to M5 all contain a copolymer of ethylene and of 1,3-butadiene in which the content of ethylene units is greater than 50%. In the composition M5, the copolymer bears a silanol or alkoxysilane function at the chain end.

The copolymer of ethylene and of 1,3-butadiene (EBR) used in the compositions M1 to M4 is prepared according to the following procedure:

The cocatalyst, the butyloctylmagnesium (BOMAG) (0.00021 mol/l) and then the metallocene [{Me₂SiFlu₂Nd(μ-BH₄)₂Li(THF)}₂] (0.07 mol/l) are added to a reactor containing methylcyclohexane, the Flu symbol representing the C₁₃H₈ group. The alkylation time is 10 minutes, the reaction temperature is 20° C. Then, the monomers in the form of a gas mixture of ethylene/1,3-butadiene molar composition: 80/20 are added continuously. The polymerization is carried out under conditions of constant temperature and pressure of 80° C. and 8 bar. The polymerization reaction is stopped by cooling, degassing of the reactor and addition of ethanol. An antioxidant is added to the polymer solution. The copolymer is recovered by drying in an oven under vacuum to constant weight.

In the EBR copolymer, the molar content of ethylene units is 79%, the molar content of 1,4 units is 6%, the molar content of 1,2 units is 8%, and the molar content of 1,2-cyclohexanediyl units is 7%. The Mooney viscosity is 85.

For the EBR-F copolymer used in the rubber composition M5, the copolymer is prepared according to the same procedure as the EBR copolymer, with one difference which is as follows:

When the desired monomer conversion is achieved, the content of the reactor is degassed and then the functionalizing agent, (N,N-dimethyl-3-aminopropyl)methyldimethoxysilane, is introduced under an inert atmosphere by excess pressure. The reaction medium is stirred for a time of 15 minutes and a temperature of 80° C. After reaction, the medium is degassed and then precipitated from methanol. The polymers are redissolved in toluene, then precipitated from methanol so as to eliminate the ungrafted “silane” molecules, which makes it possible to improve the quality of the signals of the spectra for the quantification of the function content and the integration of the various signals. The polymer is treated with antioxidant then dried at 60° C. under vacuum to constant weight.

In the EBR-F copolymer, the molar content of ethylene units is 76%, the molar content of 1,4 units is 6%, the molar content of 1,2 units is 9%, and the molar content of 1,2-cyclohexanediyl units is 9%. The Mooney viscosity is 84.

TABLE 1

| Composition | T1 | M1 | M2 | M3 | M4 | M5 |
|---|---|---|---|---|---|---|
| SBR (1) | 100 | | | | | |
| EBR (2) | | 100 | 100 | 100 | 100 | |
| EBR-F (3) | | | | | | 100 |
| Carbon black (4) | 5 | 3 | 3 | 3 | 3 | 3 |
| Silica (5) | 110 | 75 | 91 | 63 | 83 | 63 |
| Oil (6) | 20 | | | | | |
| Resin (7) | 50 | | | | | |
| Liquid | | 38 | 26 | 10 | 20 | 23 |
| plasticizing | | | | | | |
| agent (8) | | | | | | |
| Plasticizing | | 32 | 31 | 25 | 23 | 23 |
| resin (9) | | | | | | |
| Antioxidant (10) | | 2 | 2 | 2 | 2 | 2 |
| Anti-ozonant | | 1.6 | 1.6 | 1.6 | 1.6 | 1.6 |
| wax | | | | | | |
| Coupling agent | 9 | 6 | 7 | 5 | 7 | 5 |
| (11) | | | | | | |
| Stearic acid (12) | 2 | 2 | 2 | 2 | 2 | 2 |
| Zinc oxide (13) | 3 | 1 | 1 | 1 | 1 | 1 |
| DPG (14) | 2 | 1.5 | 1.8 | 1.2 | 1.5 | 1.2 |
| CBS (15) | 2 | 2 | 2 | 2 | 2 | |
| Sulfur | 1 | 1 | 1 | 1 | 1 | 1.6 |
| TBzTD (16) | | | | | | 2 |

(1) SBR—27% styrene; 5% 1,2-butadiene; 15% 1,4-cis; 80% 1,4-trans; Tg −48° C.;
(2) Copolymer of ethylene and of a non-functional 1,3-butadiene (EBR);
(3) Copolymer of ethylene and of a functional 1,3-butadiene (EBR-F);
(4) N234 according to Standard ASTM D-1765;
(5) Zeosil 1165 MP, from Solvay-Rhodia, in the form of microbeads;
(6) Flexon 630 TDAE oil from Shell;
(7) Escorez 2173 resin from Exxon;
(8) MES/HPD (Catenex SNR from Shell);
(9) Escorez 5600 C9/Dicyclopentadiene hydrocarbon resin from Exxon (Tg = 55° C.);
(10) N-1,3-Dimethylbutyl-N-phenyl-para-phenylenediamine (Santoflex 6-PPD from Flexsys);
(11) TESPT (Si69 from Evonik);
(12) Pristerene 4931 stearin from Uniqema;
(13) Zinc oxide, industrial grade from Umicore;
(14) Diphenylguanidine;
(15) N-Cyclohexyl-2-benzothiazolesulfenamide (Santocure CBS from Flexsys);
(16) Tetrabenzylthiuram disulfide (Perkacit TBZTD from Flexsys).

Table 2 below shows the values of the ratio between the filler content and the plasticizing system content.

TABLE 2

| Composition | T1 | M1 | M2 | M3 | M4 | M5 |
|---|---|---|---|---|---|---|
| Filler content/ | 1.6 | 1.1 | 1.6 | 1.9 | 2 | 1.4 |
| plasticizing | | | | | | |
| system ratio | | | | | | |

Table 3 below shows the stiffness characteristics of the six mixtures presented.

TABLE 3

| Composition | T1 | M1 | M2 | M3 | M4 | M5 |
|---|---|---|---|---|---|---|
| Ref. Internal | WO2016/ | DF059 | CW838 | CW554 | CL895 | DN538 |
| DDT | 202702 | | M07 | | | |
| G* modulus | 0.9 | 1.2 | 1.7 | 1.7 | 2.3 | 1.3 |
| at 60° C. | | | | | | |
| (MPa) | | | | | | |
| G* modulus | 100 | 133 | 189 | 193 | 256 | 144 |
| at 60° C. | | | | | | |
| (base 100) | | | | | | |

Table 3 above describes a rubber composition T1 from the prior art, used as a mixture of the central portion of the tread, and also five compositions in accordance with the invention for mixtures capable of constituting the lateral tread portions.

The rubber composition T1 comprises 100 phr of SBR and has a dynamic shear modulus of 0.9 MPa, which makes this composition suitable for providing the tyre with excellent grip due in particular to a high contact area on rough ground.

The first four compositions M1 to M4 in accordance with the invention for the lateral tread portions comprise 100 phr of the EBR diene elastomer described above and composition M5 comprises 100 phr of the EBR-F diene elastomer as described above.

These five compositions have a dynamic shear modulus of between 1.2 and 2.3 MPa, which makes them suitable for stiffening the tread and thus improving the handling of the tyre, while allowing their use in contact with a ground on which it is running, when the tyre tread is new and worn.

It should be noted that the filler content/plasticizing system content ratio varies between 1.1 and 2 (Table 2).

Finally, the filler contents of these compositions are much lower than those of composition T1, which allows a significant reduction in their hysteresis.

1.-15. (canceled)

16. A tire having an axis of rotation and a median plane perpendicular to the axis of rotation, and comprising two beads, two sidewalls connected to the beads, a crown connected to ends of the two sidewalls with a crown reinforcement, and a radially outer tread, the tread being axially separated into at least three portions including a central portion and two lateral portions,
wherein the rubber composition of the lateral portions comprises more than 50 phr of a copolymer of ethylene and of a 1,3-diene, a reinforcing filler and a plasticizing system, the 1,3-diene being 1,3-butadiene or isoprene and the ethylene units in the copolymer representing more than 50 mol % of all the monomer units of the copolymer.

17. The tire according to claim 16, wherein the tread comprises a plurality of tread pattern elements with lateral faces and a contact face intended to come into contact with a roadway when the tire is running and a plurality of circumferential grooves each delimited by lateral faces of adjacent tread pattern elements that face one another, and delimited by a base, the central portion extending axially on either side of the median plane of the tire beyond the plurality of circumferential grooves.

18. The tire according to claim 16, wherein the tread comprises a plurality of tread pattern elements with lateral faces and a contact face intended to come into contact with a roadway when the tire is running and a plurality of circumferential grooves each delimited by lateral faces of adjacent tread pattern elements that face one another, and delimited by a base, the central portion extending axially to an axially outermost circumferential groove, at least on one side of the median plane of the tire.

19. The tire according to claim 17, wherein the central portion extends axially to an axially outermost circumferential groove on either side of the median plane of the tire, and
wherein the central portion includes the bases of the circumferential grooves.

20. The tire according to claim 16, wherein the tread comprises a radially inner first layer C1 and a radially outer second layer C2, the lateral portions of the first layer C1 constituting the lateral portions and the second layer C2 constituting the central portion.

21. The tire according to claim 16, wherein the 1,3-diene is 1,3-butadiene.

22. The tire according to claim 16, wherein the copolymer contains units of formula (I) or units of formula (II) or units of formula (I) and of formula (II)

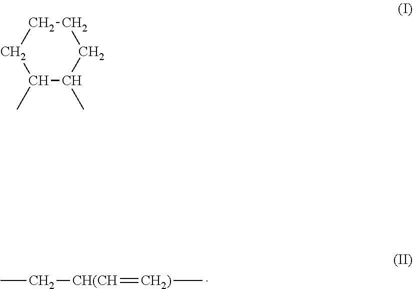

23. The tire according to claim 22, wherein molar percentages of the units of formula (I) and of the units of formula (II) in the copolymer, respectively o and p, satisfy the following equation 1, o and p being calculated on a basis of all the monomer units of the copolymer
0<o+p≤25 (eq. 1)

24. The tire according to claim 16, wherein the reinforcing filler of the rubber composition of the lateral portions comprises from 35 to 100 phr of a reinforcing filler which comprises a silica.

25. The tire according to claim 16, wherein the plasticizing system of the rubber composition of the lateral portions comprises a hydrocarbon-based plasticizing resin and a hydrocarbon-based liquid plasticizing agent, a total content of hydrocarbon-based plasticizing resin and of hydrocarbon-based liquid plasticizing agent being greater than 10 phr and less than or equal to 80 phr.

26. The tire according to claim 16, wherein a weight ratio between the content of reinforcing filler and a content of the plasticizing system of the rubber composition of the lateral portions is greater than or equal to 1.1.

27. The tire according to claim 16, wherein the copolymer of ethylene and of a 1,3-diene is the only elastomer of the rubber composition of the lateral portions.

28. The tire according to claim 16, wherein the rubber composition of the central portion comprises less than 50 phr of a copolymer of ethylene and of a 1,3-diene.

29. The tire according to claim 16, wherein a dynamic shear modulus of the rubber composition of the lateral portions is between 1 and 2.5 MPa, the dynamic shear modulus being measured at 60° C. during a temperature sweep at an imposed stress of 0.7 MPa and at a frequency of 10 Hz.

30. The tire according to claim 16, wherein a ratio K between a dynamic shear modulus of the rubber composition of the lateral portions and a dynamic shear modulus of the rubber composition of the central portion is greater than 1.1, the dynamic shear moduli being measured at 60° C. during a temperature sweep at an imposed stress of 0.7 MPa and at a frequency of 10 Hz.
